(19) United States
(12) Patent Application Publication
(10) Pub. No.: US 2015/0363874 A1
(43) Pub. Date: Dec. 17, 2015

(54) SYSTEMS, MEDIA, AND METHODS FOR DISTRIBUTED ENERGY PROJECT FINANCING

(71) Applicant: Demeter Power Group, Inc., West Palm Beach, FL (US)

(72) Inventors: Michael Wallander, West Palm Beach, FL (US); Yann Brandt, Lauderdale-By-The-Sea, FL (US); Philip Tinsley, Flower Mound, TX (US)

(21) Appl. No.: 14/302,381

(22) Filed: Jun. 11, 2014

(51) Int. Cl. G06Q 40/02

(52) U.S. Cl. CPC G06Q 40/025

(57) ABSTRACT

Computer-based systems, media, and methods for sourcing, analyzing and calculating and underwriting the financing of distributed energy systems affixed to real property with the financing payments secured by a lien placed by a governmental authority. A web-based calculator tool is enabled to facilitate web searches used to collect required necessary information to create a project finance profile and to calculate and display results to property owners and to contractors or other channel partners. In some cases, the tool is further used to underwrite the project financing and displaying whether a project is preliminarily credit-approved. In further cases, the tool further enables pre-setting project finance assumptions for offering standard fixed-pricing to project applicants arranged by utility tariff, city or county or zip code subject to particular program parameters.

### BACKGROUND OF THE INVENTION

Distributed energy projects, which broadly include customer-sited solar installations, wind farms, electric vehicle solutions, fuel cell installations and energy storage installations, have been recognized as a key strategy to addressing climate change and to more effectively meeting the energy needs of global society.

### SUMMARY OF THE INVENTION

The present invention generally relates to a distributed energy project financing system, and more particularly to a web-enabled calculator for evaluating, underwriting and financing distributed energy systems. A proliferation of financing strategies have been used to address and mitigate project finance risks in a variety of transaction types that include loans (debt transactions), as well as solar lease and power purchase agreements (PPA) and other forms of energy services contracts (third-party ownership transactions).

A principal challenge with distributed energy project finance is ensuring the project is sufficiently creditworthy to ensure repayment of the financing. Financing is typically dependent upon the project owner's credit, which in turn depends upon the security of the cash flow to the project. Thus, the project credit-profile depends upon an evaluation of the payee's credit. For instance, a residential distributed energy project may depend upon a homeowner-customer's credit, which can be evaluated by examining the homeowner's credit score. A utility-sponsored feed-in tariff (FiT) project has required an examination of the utility-provider's bond or credit-rating. A commercial distributed-energy project has required an examination of the commercial customer's financial statements, cash flow and collateral used to secure payment in the form of a personal or corporate guarantee.

Governments and utility providers have introduced a variety of policy tools to help leverage private financing, including tax incentives and rebates, as well as programs that mitigate the need for project-specific credit criteria, such as FiT and renewable portfolio standard (RPS) programs, which may involve payments by the governmental or utility energy provider for all or a portion of the distributed energy attributes. For example, a FiT is generally for a purchase of the energy from an energy project while an RPS is generally for a purchase of the renewable or clean energy attributes separate and apart from the purchase of the energy; both rely upon the governmental or utility provider's, not the project-owner's, credit.

In one example of a public-private partnership policy tool known as “property-assessed clean energy” or PACE, a local government sponsors creation of an energy improvement special taxing district enabling a property-owner customer to voluntarily opt-in to this district and to pledge to pay a special tax assessment the collection of which is used to secure payment of a revenue stream over a term of years. This enables a governmental entity to place an assessment or tax lien on the property (i.e., real property), which is used to secure the repayment, collected as a line item on the property tax bill. This PACE-secured revenue stream can be used to finance either loans or leases and services contracts.

These various methods of financing distributed energy projects have different impacts on the cost of capital to the project. The cost of capital to the project is only one element, however, in determining the value proposition to a customer and to other project participants and stakeholders. Other costs that affect this value proposition include soft costs (e.g., advertising and marketing costs of customer acquisition, permitting, system design, legal and accounting transaction costs and financing costs) as well as the costs of engineering, procuring system components and constructing the system (EPC costs). Ultimately, the value proposition of a distributed energy project must translate to a cost that compares favorably with the cost of obtaining the energy from another source, such as the utility, on a per kilowatt hour basis over the term of the prospective customer contract—i.e., the levelized cost of energy (LCOE) of the project.

The complexity of these factors has generally resulted in distributed energy projects being originated primarily by entrepreneurial actions that seek to assemble all of the participants needed for a successful project, which can include the sponsor, the EPC contractor, the technology provider, the operations and maintenance (O&M) servicer, the energy off-taker (e.g., customer or utility) and the grid operator, as well as all of the factors necessary for an examination of the financeability of the transaction (the power purchase agreement, proof of site control or access, the interconnection agreement with the utility, etc.). As has been recognized by global financiers, the financing in these transactions comes last—not first—which is in contrast to the expectations of the international development finance community, where the financing comes first and is generally backed by a government. See, e.g., Michael Eckhart, Attracting Low-Cost Capital to Clean Energy, Envtl. Fin., Apr. 3, 2013.

Thus, the question asked and answered herein is: can a computer-implemented system be developed that significantly simplifies the financial analysis of a distributed energy project using only a project site address? Further, can a computer-implemented system be developed that enables the quotation of prospective fixed-pricing for such a project?

The systems, media, and methods described herein utilize a significantly improved structure that enables the quotation of distributed energy project pricing to customers and/or to project contractors or other channel sourcing partners based only on the provision of a project site address. The systems, media, and methods described herein also advantageously enable the quotation of prospective fixed-pricing for projects based on a range of project assumptions and requirements assuming they can be satisfied by project applicants.

In one aspect, disclosed herein are computer-implemented systems comprising: a digital processing device comprising an operating system configured to perform executable instructions and a memory; and a computer program including instructions executable by the digital processing device to create a distributed energy project finance application comprising: a software module configured to provide an interface for allowing a user to input real property identification information; a software module configured to conduct a plurality of search queries based on the real property identification information, the web search queries used to gather additional information about the real property from public and private databases, the additional information about the real property used to generate distributed energy project system design parameters; a software module configured to analyze the system design parameters together with project finance parameters to assess potential energy cost savings to be received by the property owner from installation of a distributed energy system affixed to the real property; a software module configured to display potential energy cost savings as a property owner economic benefit expressed as a discount off current energy prices; a software module configured to provide access to design optimization recommendation tools and enable the user to adjust the system design parameters; a software module configured to calculate final projected energy cost savings from installation of the distributed energy system pursuant to the final system design parameters and project finance parameters; and a software module configured to generate a customer term sheet that memorializes the finalized system design and project finance parameters. In some embodiments, the real property identification comprises address, assessor's parcel number (APN), or latitude and longitude coordinates, or a combination thereof. In further embodiments, the real property identification consists of an address. In some embodiments, the additional information about the real property comprises one or more of: the property owner's legal name, building use, building type, building square footage, number of floors, tax parcel identification number, appraised value, financial or other liens, energy usage, current utility, current time of use and demand charges, and geographic potential for renewable energy. In some embodiments, the project finance parameters comprise one or more of: investor required rates of return, term, transaction costs, incentives, underwriting costs and requirements, distributed energy system type, and distributed energy system size. In some embodiments, the application further comprises a software module configured to calculate potential installation cost received by a distributed energy system installer. In some embodiments, the software module configured to display potential energy cost savings further displays a channel partner installation cost or project origination fee amount. In some embodiments, the system is used to evaluate whether predetermined project underwriting metrics are preliminarily satisfied and to enable displaying results and generating a project term sheet that may be marketed as credit pre-qualified or as credit pre-approved. In some embodiments, the application is a web application. In some embodiments, the project finance parameters comprise one or more pre-set project finance assumptions. In some embodiments, the application further comprises a software module configured to display a plurality of standard fixed-price offers in the form of a matrix arranged by utility tariff, rate structure, city, county, or zip code.

In another aspect, disclosed herein are non-transitory computer-readable storage media encoded with a computer program including instructions executable by a processor to create a distributed energy project finance application comprising: a software module configured to provide an interface for allowing a user to input real property identification information; a software module configured to conduct a plurality of search queries based on the real property identification information, the web search queries used to gather additional information about the real property from public and private databases, the additional information about the real property used to generate distributed energy project system design parameters; a software module configured to analyze the system design parameters together with project finance parameters to assess potential energy cost savings to be received by the property owner from installation of a distributed energy system affixed to the real property; a software module configured to display potential energy cost savings as a property owner economic benefit expressed as a discount off current energy prices; a software module configured to provide access to design optimization recommendation tools and enable the user to adjust the system design parameters; a software module configured to calculate final projected energy cost savings from installation of the distributed energy system pursuant to the final system design parameters and project finance parameters; and a software module configured to generate a customer term sheet that memorializes the finalized system design and project finance parameters. In some embodiments, the real property identification comprises address, assessor's parcel number (APN), or latitude and longitude coordinates, or a combination thereof. In further embodiments, the real property identification consists of an address. In some embodiments, the additional information about the real property comprises one or more of: the property owner's legal name, building use, building type, building square footage, number of floors, tax parcel identification number, appraised value, financial or other liens, energy usage, current utility, current time of use and demand charges, and geographic potential for renewable energy. In some embodiments, the project finance parameters comprise one or more of: investor required rates of return, term, transaction costs, incentives, underwriting costs and requirements, distributed energy system type, and distributed energy system size. In some embodiments, the application further comprises a software module configured to calculate potential installation cost received by a distributed energy system installer. In some embodiments, the software module configured to display potential energy cost savings further displays a channel partner installation cost or project origination fee amount. In some embodiments, the application is used to evaluate whether predetermined project underwriting metrics are preliminarily satisfied and to enable displaying results and generating a project term sheet that may be marketed as credit pre-qualified or as credit pre-approved. In some embodiments, the application is a web application. In some embodiments, the project finance parameters comprise one or more pre-set project finance assumptions. In some embodiments, the application further comprises a software module configured to display a plurality of standard fixed-price offers in the form of a matrix arranged by utility tariff, rate structure, city, county, or zip code.

In another aspect, disclosed herein are computer-implemented methods of assessing financing for a distributed energy project comprising: receiving, by a computer, real property identification information entered by a user; conducting, by the computer, a plurality of search queries based on the real property identification information, the web search queries used to gather additional information about the real property from public and private databases, the additional information about the real property used to generate distributed energy project system design parameters; analyzing, by the computer, the system design parameters together with project finance parameters to assess potential energy cost savings to be received by the property owner from installation of a distributed energy system affixed to the real property; displaying, by the computer, potential energy cost savings as a property owner economic benefit expressed as a discount off current energy prices; providing, by the computer, user access to design optimization recommendation tools and enable the user to adjust the system design parameters; calculating, by the computer, final projected energy cost savings from installation of the distributed energy system pursuant to the final system design parameters and project finance parameters; and generating, by the computer, a customer term sheet that memorializes the finalized system design and project finance parameters. In some embodiments, the real property identification comprises address, assessor's parcel number (APN), or latitude and longitude coordinates, or a combination thereof. In further embodiments, the real property identification consists of an address. In some embodiments, the additional information about the real property comprises one or more of: the property owner's legal name, building use, building type, building square footage, number of floors, tax parcel identification number, appraised value, financial or other liens, energy usage, current utility, current time of use and demand charges, and geographic potential for renewable energy. In some embodiments, the project finance parameters comprise one or more of: investor required rates of return, term, transaction costs, incentives, underwriting costs and requirements, distributed energy system type, and distributed energy system size. In some embodiments, the method further comprises calculating, by the computer, potential installation cost received by a distributed energy system installer. In some embodiments, displaying potential energy cost savings further comprises displaying, by the computer, a channel partner installation cost or project origination fee amount. In some embodiments, the method is used to evaluate whether predetermined project underwriting metrics are preliminarily satisfied and to enable displaying results and generating a project term sheet that may be marketed as credit pre-qualified or as credit pre-approved.

A distributed energy project financing system embodied in the present invention begins with an application for project financing by an owner of real property or by a contractor, developer, consultant or other channel partner that is working with the property owner to evaluate and complete such a project. As a condition of the project finance application, the owner of real property agrees to enter into a voluntary assessment contract with a governmental provider and to the placement of a senior lien against the real property to secure repayment of financing for a fixed number of years. The payments owed by the property owner are secured by a governmental authority as revenue to be used as security for issuance of a bond. The bond is issued and the proceeds are disbursed to the property owner, contractor, equipment lessor or energy services company and used to fund at least a portion of the upfront costs of the installation. The financing may be in the form of a loan, a lease or a services fee, provided that the value proposition of the transaction is quoted to the project applicant as the anticipated post-project energy savings to the property site based upon a range of assumptions. These assumptions may include, but are not limited to, information about the project site, the project participants and project costs; they are input into a project finance calculator and may be sourced from a web-enabled project input system and search engine. Together, the assumptions are used to evaluate and underwrite the project finance application. The assumptions may be assumed in advance as a checklist of project requirements in order to provide a fixed-price offer to project participants.

The purpose or object of the present invention is to source, originate, research, evaluate, quantify and underwrite applications for distributed energy project financing. The utilization of pre-project assumptions, sufficient to provide an on-demand project finance quotation, are further refined through the web-enabled project sourcing process, are used to lower the costs of customer acquisition and to improve the accuracy of credit aspects of the project or to improve the ease and efficiency with which underwriting applications are processed.

The key innovation of an embodiment of the present invention is the use of a web-enabled project sourcing and search-engine enabled system to gather at least one initial input of a project address from a project applicant. This input address is then used as a search query to seek and obtain additional information about the property for use in completing an energy project profile. The search queries may be issued to public and private databases to gather such information as is routinely used to underwrite commercial mortgages (e.g., ownership entity and status, financial or mortgage liens, property use and type, tax and mortgage payment history, neighborhood and comparative property analysis, etc.) together with information used to evaluate the site's distributed energy project potential (e.g., geographic potential for solar irradiation, geothermic potential, climactic conditions, state or local government incentives, etc.). The search query could include an identification of the property using internet mapping software and satellite imagery to obtain an image of the site that is used to aide in the engineering and design of the distributed energy system. Once a project application is sourced, the invention enables to the refinement of the project information to improve the accuracy of the underlying project assumptions, including site-information, credit and underwriting information, project participants, system design and project costs. The project input assumptions are then run through a cloud-based project finance calculator and used to display calculator results, project metrics and a customer project value proposition. A project applicant that is satisfied with the prospective project value proposition may then select an option to generate a project term sheet.

Another embodiment of the present invention involves the use of the web-enabled sourcing tool to offer an alternative standard offer at a fixed price to a project participant that meets certain pre-project requirements by a certain date or within a certain time period. Such fixed-pricing may be provided via the website in the form of a project-financing matrix or other format and may be grouped according to such information as zip code, city or county, utility service territory or tariff rate, or some other project grouping or aggregation criteria.

These and other objects and advantages of the present invention should be understood to those of ordinary skill in the art after having read the following detailed description and supporting figures herein.

### BRIEF DESCRIPTION OF THE DRAWINGS

FIG. 1 shows a non-limiting example of a schematic functional diagram illustrating a traditional PACE financing transaction.

FIG. 2 shows a non-limiting example of a schematic functional diagram illustrating a lease or services agreement financial product and a business method offering significant improvements over traditional PACE financing transactions.

FIG. 3 shows a non-limiting example of a schematic flowchart illustrating cash flow and a business method offering significant improvements over traditional PACE financing transactions.

FIG. 4 shows a non-limiting example of a schematic flowchart illustrating a sales and financing process to proceed to financial closing a lease or services agreement within a property assessed clean energy program offering significant improvements over traditional PACE financing transactions.

FIG. 5 shows a non-limiting example of a schematic functional diagram of a web-enabled distributed energy project finance calculator; in this case, a calculator including an underwriting tool and funding portal, which is used to originate project finance applications.

FIG. 6 shows a non-limiting example of a user interface for a distributed energy project finance calculator; in this case, a calculator including a text field to enter a property address and buttons to indicate a user type such as property owner or contractor.

FIGS. 7 and 8 show non-limiting examples of a user interface for a distributed energy project finance calculator; in this case, a calculator including an auto-complete feature for the entry of a property address.

FIG. 9 shows a non-limiting example of a user interface for a distributed energy project finance calculator; in this case, a calculator including a registration requirement for contractor users.

FIG. 10 shows a non-limiting example of a user interface for a distributed energy project finance calculator; in this case, a calculator including an animated wait screen used when web searches are being conducted to identify additional information for a property address.

FIG. 11 shows a non-limiting example of a user interface for a distributed energy project finance calculator; in this case, a calculator including a satellite view result screen for a property, the results including a parcel map containing an image overlay showing parcel boundaries and inviting a user to click a pin within the parcel boundaries to select a particular real estate parcel.

FIG. 12 shows a non-limiting example of a user interface for a distributed energy project finance calculator; in this case, a calculator including a satellite view result screen for a property, the results including property owner, projected solar energy savings, discount off utility rate, increase to property value and elements to access a tool to refine the estimate.

FIG. 13 shows a non-limiting example of a user interface for a distributed energy project finance calculator; in this case, a calculator including a map view result screen for a property, the results including property owner, projected solar energy savings, discount off utility rate, increase to property value and elements to access a tool to refine the estimate.

FIG. 14 shows a non-limiting example of a user interface for a distributed energy project finance calculator; in this case, a calculator including a term sheet request input form for summarizing project information, contractor information, site information, and utility information.

FIG. 15 shows a non-limiting example of a user interface for a distributed energy project finance calculator; in this case, a calculator including a project information form for summarizing and refining project parameters.

FIG. 16 shows a non-limiting example of a user interface for a distributed energy project finance calculator; in this case, a calculator including an underwriting representations form.

FIG. 17 shows a non-limiting example of a user interface for a distributed energy project finance calculator; in this case, a calculator including a report of customer benefits of the project over thirty years.

FIG. 18 shows a non-limiting example of a user interface for a distributed energy project finance calculator; in this case, a calculator including a summary of annual and cumulative monetary benefits to the property owner over thirty years.

FIG. 19 shows a non-limiting example of a user interface for a distributed energy project finance calculator; in this case, a calculator including a summary of annual and cumulative monetary benefits to the property owner and the tenant over thirty years.

FIG. 20 shows a non-limiting example of a user interface for a distributed energy project finance calculator; in this case, a calculator including a summary of annual and cumulative monetary benefits to the property owner over thirty years.

FIG. 21 shows a non-limiting example of a user interface for a distributed energy project finance calculator; in this case, a calculator including a summary of project terms and conditions in the form of project term sheet.

### DETAILED DESCRIPTION OF THE INVENTION

Described herein, in certain embodiments, are computer-implemented systems comprising: a digital processing device comprising an operating system configured to perform executable instructions and a memory; and a computer program including instructions executable by the digital processing device to create a distributed energy project finance application comprising: a software module configured to provide an interface for allowing a user to input real property identification information; a software module configured to conduct a plurality of search queries based on the real property identification information, the web search queries used to gather additional information about the real property from public and private databases, the additional information about the real property used to generate distributed energy project system design parameters; a software module configured to analyze the system design parameters together with project finance parameters to assess potential energy cost savings to be received by the property owner from installation of a distributed energy system affixed to the real property; a software module configured to display potential energy cost savings as a property owner economic benefit expressed as a discount off current energy prices; a software module configured to provide access to design optimization recommendation tools and enable the user to adjust the system design parameters; a software module configured to calculate final projected energy cost savings from installation of the distributed energy system pursuant to the final system design parameters and project finance parameters; and a software module configured to generate a customer term sheet that memorializes the finalized system design and project finance parameters.

Also described herein, in certain embodiments, are non-transitory computer-readable storage media encoded with a computer program including instructions executable by a processor to create a distributed energy project finance application comprising: a software module configured to provide an interface for allowing a user to input real property identification information; a software module configured to conduct a plurality of search queries based on the real property identification information, the web search queries used to gather additional information about the real property from public and private databases, the additional information about the real property used to generate distributed energy project system design parameters; a software module configured to analyze the system design parameters together with project finance parameters to assess potential energy cost savings to be received by the property owner from installation of a distributed energy system affixed to the real property; a software module configured to display potential energy cost savings as a property owner economic benefit expressed as a discount off current energy prices; a software module configured to provide access to design optimization recommendation tools and enable the user to adjust the system design parameters; a software module configured to calculate final projected energy cost savings from installation of the distributed energy system pursuant to the final system design parameters and project finance parameters; and a software module configured to generate a customer term sheet that memorializes the finalized system design and project finance parameters.

Also described herein, in certain embodiments, are computer-implemented methods of assessing financing for a distributed energy project comprising: receiving, by a computer, real property identification information entered by a user; conducting, by the computer, a plurality of search queries based on the real property identification information, the web search queries used to gather additional information about the real property from public and private databases, the additional information about the real property used to generate distributed energy project system design parameters; analyzing, by the computer, the system design parameters together with project finance parameters to assess potential energy cost savings to be received by the property owner from installation of a distributed energy system affixed to the real property; displaying, by the computer, potential energy cost savings as a property owner economic benefit expressed as a discount off current energy prices; providing, by the computer, user access to design optimization recommendation tools and enable the user to adjust the system design parameters; calculating, by the computer, final projected energy cost savings from installation of the distributed energy system pursuant to the final system design parameters and project finance parameters; and generating, by the computer, a customer term sheet that memorializes the finalized system design and project finance parameters.

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Overview

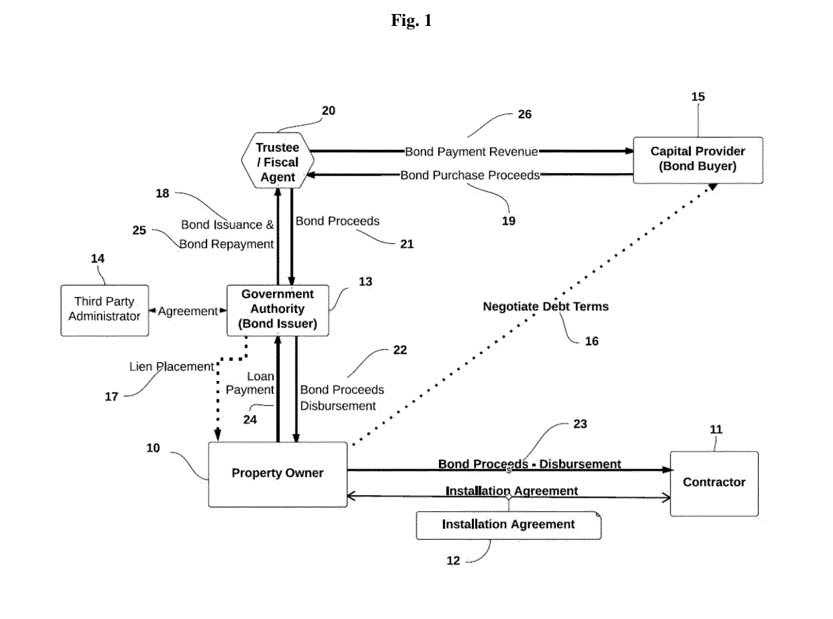

Referring to FIG. 1, an exemplary schematic diagram represents what is generally known about a typical PACE financing transaction, wherein: (a) a property owner 10, which may include, but is not limited to residential, agricultural, commercial or industrial, may choose to enter into an agreement with a contractor 11 to install energy-related and other eligible property improvements, which may be pursuant to a purchase and installation agreement 12 or, alternatively, a purchase agreement for a pre-paid lease or services agreement; (b) the property owner 10 elects to enter into a voluntary assessment agreement with a special tax or assessment district established by governmental authority 13, which may be a city or county or multi-jurisdictional governmental entity, which in turn may be administered by a third party administrator 14, in order to secure financing for the purchase of the installation (or, alternatively, the purchase of the pre-paid lease or services agreement); (c) the property owner 10 and a capital provider 15 may negotiate for financing for the project 16; (d) pursuant to an agreement with the governmental authority 13, the property owner 10 agrees to have the governmental authority 13 place a senior lien against the property that is generally co-equal with a tax lien 17; (e) the governmental authority issues a bond 18 secured by the revenue from the debt transaction with the property owner 10; (f) the capital provider 15 purchases the bond and disburses funds 19 to the governmental provider's fiscal agent 20, or to the governmental provider 21 and ultimately to the property owner 22; (g) the property owner receives the disbursement of funds and pays (or, alternatively, assigns its right to receive the proceeds directly to) the contractor 23 for the cost of the installation (or, alternatively, to purchase a pre-paid lease or service contract); and (h), the property owner is then responsible for paying an assessment on their property tax bill representing the debt amount to the governmental provider 24, which is collected and serviced by the trustee or fiscal agent 20 and in a private bond financing would be used to distribute the bond proceeds to pay the capital provider 26 for the principal and interest of the bond payments.

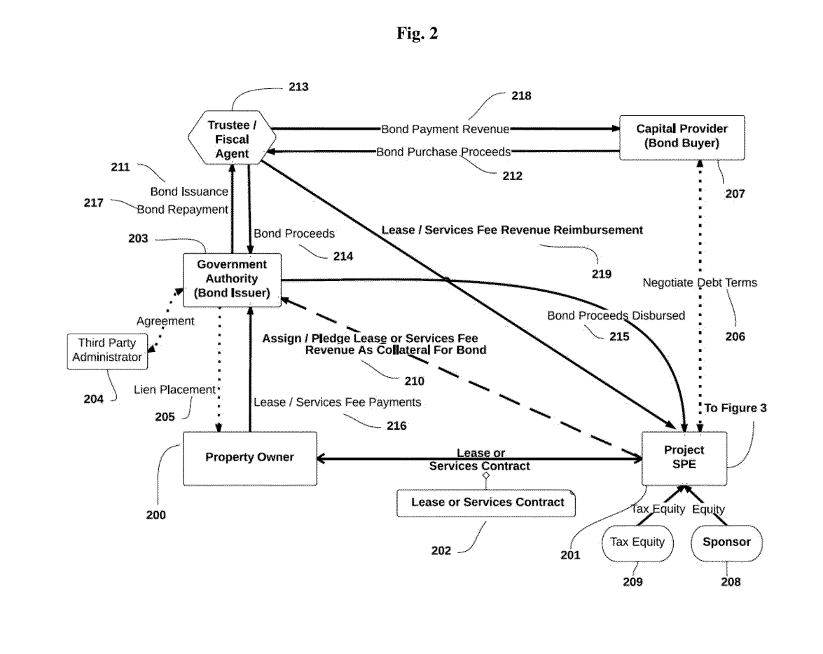

Referring to FIG. 2, another exemplary schematic diagram represents new and unique modifications to a typical PACE financing transaction, wherein: (a) a property owner 200, which may include, but is not limited to residential, agricultural, commercial or industrial, and a third party 201, which may be, but is not limited to being, an energy equipment lessor or energy services provider or a project special purpose entity (hereinafter “Project SPE”), enters into an agreement 202, which agreement may be either a lease agreement or a services agreement; (b) as a condition of entering into the lease agreement or services agreement, the property owner 200 must contemporaneously (or soon thereafter) enter into an agreement with a government authority 203, which governmental provider may include, but is not limited to, a city or a county or a special tax or assessment district or a multi-jurisdictional authority, each of which in turn may be administered by a third party administrator 204, pursuant to which the property owner 200 promises to pay the lease payment or services fee owed to the Project SPE 201 to the governmental provider 203; (c) the property owner 200 agrees to have the governmental provider 204 place a senior lien against the property 205, which lien is generally co-equal with a tax lien, in order to secure payment of the lease payment or services fee owed to the Project SPE 201; (d) the Project SPE 201 uses the property owner's promise to pay the lease or services fee secured by the governmental authority's senior lien on the property 205 and pledges to assign its revenue, which may be lease payments or services fees, to the governmental authority as collateral to negotiate debt funding 206 from a capital provider 207, which funding will be used to pay for some or all of the installation cost of the distributed energy project, which funding may also come from public sources or from private sources, such as, but not limited to an equity investor or co-sponsor 208 and a tax equity investor 209; (e) if in a private financing with funding by a capital provider 207, the Project SPE pledges and assigns its revenue 210, in the form of either lease or services fee payments, which revenue is further secured by the property owner's 200 promise to pay the lease payment or services fee directly to the governmental authority, and which is then used as collateral for the governmental authority to issue a bond 211 that is purchased by the capital provider 207 and bond proceeds are disbursed 212 first to the governmental provider's fiscal agent 213, and/or to the governmental authority 214, but in either case, ultimately to the Project SPE 215 and reflected as a debt on the Project SPE's balance sheet; (f) the property owner 200 is then obligated to pay the lease payments or services fee payments owed to the Project SPE 201 directly to the governmental authority 216 on an ongoing basis, with the ongoing payments collected and managed by the trustee/fiscal agent 217 and used to repay the capital provider 218, any administrative and servicing fees of the governmental authority 203 and trustee/fiscal agent 212 and ultimately to distribute the balance of proceeds to the Project SPE 219 for distribution to any equity co-sponsor 208 or tax equity 209 investors.

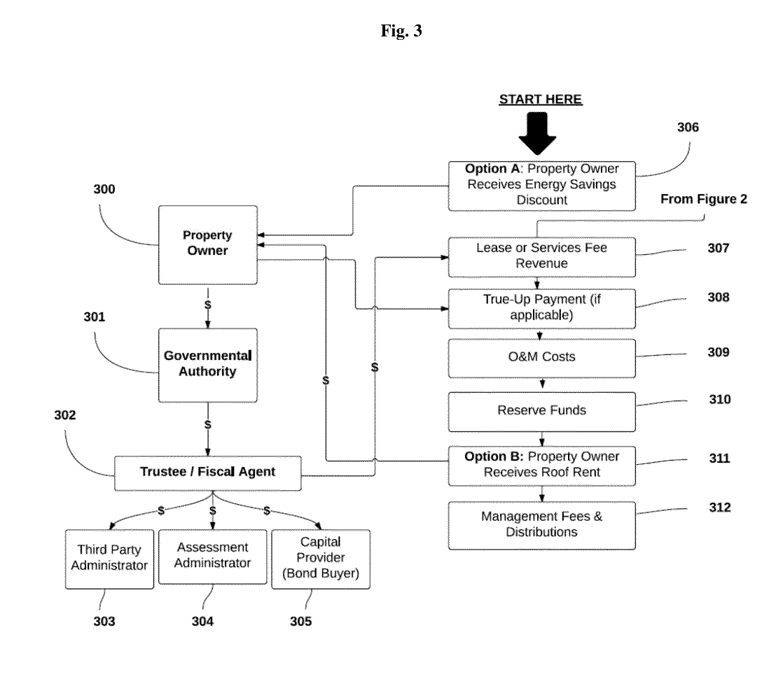

Referring to FIG. 3, another exemplary schematic diagram represents cash flow model alternatives depending upon choices made available to a property owner 300 by the Project SPE. If a property owner elects to enter into a lease transaction as offered by the Project SPE, the property owner may receive an energy savings discount 306. In the future, the property owner (or their tenant) may generally receive 100% of the future energy-related benefits of use of the energy improvements to the real property. The property owner agrees to pay a fixed fee to the Project SPE that is collected by the governmental authority 301, which may be distributed to a trustee/fiscal agent 302. The fee may be used to pay administrative expenses to a third party administrator 303, assessment administrator 304 and to make principal and interest payments to a capital provider 305. The balance is distributed to the Project SPE as its lease or services fee revenue 307. If, however, a property owner desires a services contract, rather than a lease contract, this provides added flexibility to receive the energy-related benefits either as an energy saving discount 306 or, alternatively, as rent payments (e.g., roof rent) for leasing the site 311. This is advantageous for commercial property owners who are not responsible for paying for their tenants' utility expenses and who may not have a direct incentive to lowering their tenants' energy bills. This enables such a property owner to receive rental income rather than an energy savings discount.

Continuing to refer to FIG. 3, the structure allows for separate true-up payments 308 outside of the PACE assessment to manage future risks due to fluctuations in energy production, market price changes, actual energy savings, etc. The novel financial mechanism can be structured to provide cash flow sufficient to pay for all debt payments (principal and interest) to the PACE bond holder 305, all administrative costs to the PACE and assessment administrators 303, 304, 305, and all operation and maintenance (O&M) costs 309. Once cash flow is assured to fund these base costs, the true-up mechanism 308 together with a reserve fund 310 may be used to allocate risk and reward of the aforementioned future risks and to align risk and investment return profiles between property owner and the Project SPE and its equity owners. The balance of funds are disbursed as management fees to the manager of the Project SPE and distributions to the equity owners of the Project SPE 312.

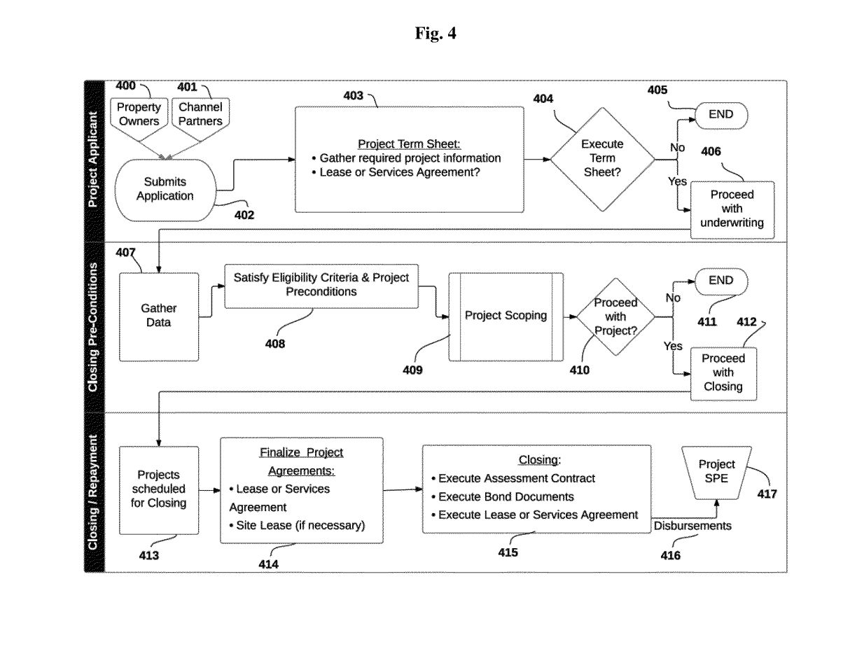

Referring to FIG. 4, another schematic diagram represents a business method for selling the financial products enabled by the business model embodiment of the present invention. The provider may provide access to an Internet web portal to property owners 400 and certain channel partners 401 to submit an application 402 for financing using either a lease or services agreement through a PACE program. Basic information about the project is collected via a web form application 402 sufficient for the parties to generate and execute a term sheet regarding material terms of the agreement 403. The property owner has a choice to execute a term sheet 404. If not executed, the sales process ends 405. If the term sheet is executed, the seller proceeds with underwriting 406 and gathers additional data 407, including but not limited to information from the property owner and about the project sufficient to demonstrate compliance with eligibility and underwriting requirements 408 and to scope the project 409. The property owner is given a choice as to whether to proceed with the project based upon the proposed scope 410. If the property owner elects not to proceed, then the sales process ends 411. If the property owner elects to proceed with the project, the process proceeds to closing 412. The projects are scheduled for closing 413, project agreements are drafted and finalized 414 and closing occurs 415, funds are disbursed 416 to the Project SPE 417. The present invention enables a more streamlined underwriting process by bringing uniformity to credit analysis. Usually, underwriting requires a deal by deal analysis of the customer's personal or corporate credit. The business model embodiment of the present invention focuses underwriting and credit analysis on the underlying real property and compliance with PACE programmatic criteria sufficient for PACE lien placement. This, in turn, enables the provider to source capital with more certainty by entering into capital sourcing agreements conditioned upon hitting pre-determined project internal rates of return (IRRs) pursuant to standardized underwriting terms. This creates scalability of financing and enables a provider to model for offering (i) a fixed price for payment of an installation to a project developer or (ii) a desired energy discount or economic benefit with a property owner. An online platform could be hosted on the Internet to educate customers, and allow them to select lease or services agreement options (together with purchase or loan options) that factor in their own information, circumstances, tax rates, credit information, landlord-tenant relationship, etc. The online platform could be used to source projects from channel partners and property owners and to provide a calculator function that enables project applicants to manipulate variables and arrive at a deal price. For example, a solar developer could input basic project information—jurisdiction, utility rate, expected system output, and requested installation cost—and receive an output that identifies the expected property owner energy rate or discount.

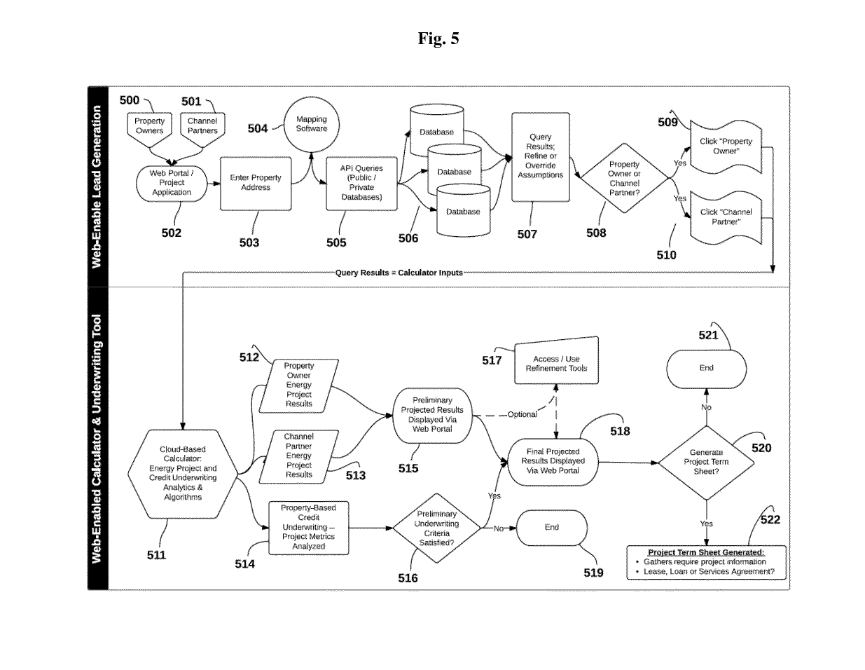

Referring to FIG. 5, in a particular embodiment, a web-enabled project finance calculator, underwriting tool, and internet funding portal, includes: a property owner 500, which may include, but is not limited to residential, agricultural, commercial or industrial, and/or a third party 501, which may be, but is not limited to being, a contractor, energy equipment lessor or energy services provider, consultant or other channel partner, may submit an application 502 for distributed energy project financing. Basic information about the project, primarily the project site address 503, is collected via this web form application. As the user is submitting the application, the user must specific whether they are a property owner or a contractor or other channel partner 504. Depending upon the selection, the web tool will use this information to generate a project financing quotation geared towards either a property owner 505 or the channel partner 506. The web tool software employs various application programming interfaces 507 to generate search queries to various public and private databases 508 to gather such information as, but not limited to, property parcel number, property owner and owner entity type, property square footage, number of floors, vintage, use and type, building shape, assessed value, appraised value, fair market value, sales and ownership history, census tract, construction type and quality, heating and cooling, existence of liens, lien-type, amount, mortgage or loan amount, interest rate, lender name and address, taxes owed and paid, tax-payment history or delinquency, roof type and condition status, latitude and longitude, environmental considerations and any other information routinely used by commercial mortgage originators to evaluate a site's potential impact on mortgage underwriting considerations. Additionally, the web tool generates search queries to various public and private databases to gather such information as, but not limited, utility provider, utility rate tariff, geographic potential for solar, assumed energy load profiles, optimal system size assumptions as arranged by building type, size, use and vintage, and any other information routinely used to evaluate the site's energy usage and energy costs and that may be used by an energy project finance underwriter. Additionally, the web tool software may integrate with mapping or satellite imagery software 509 and the provision of an address, or latitudinal and longitudinal inputs to generate an image of the site used to enable the use of software to aide in distributed energy system design or refinement, and to overlay other geographic-based parameters, such as, but not limited to, shading history, geothermal factors, state and local government considerations like permitting systems or rebate programs, etc. The query search results 510 are then used as inputs into a cloud-based calculator and energy project finance credit-underwriting tool 511. The calculator tool 511 uses additional base-level assumptions that are supplied by the web tool owner or host as either fixed inputs or algorithm-derived parameters, including, but not limited to, energy system type, size, system cost, project finance contract type (loan, lease, services contract), current utility rate, desired discount off utility rate, installation price, cost of capital and rate of return requirements (debt and/or equity), project origination costs (origination fee or developer fee), permitting fees, system design costs, legal, finance and accounting transaction costs, administrative or servicing fees and costs, including for the placement of any lien and the collection of payments, rebates and incentives, operating costs, reserve requirements, tax rates, and other information that is generally used by an energy professional skilled in the art of project finance and development to evaluate the cost and value proposition of an energy project. The outputs from the calculator may be supplied in one or various forms, including, but not necessarily limited to, as the value proposition to a property owner 512 or a channel partner 513. The calculator results are also used as inputs into software that analyzes whether various project-underwriting metrics and ratios may be satisfied 514. Preliminary calculator value-proposition results are displayed via a web-portal, which may be overlaid against a website map of the property 515, for viewing by a property owner, channel partner or other web-user. At that time, the results may also display whether project finance underwriting criteria has been preliminarily satisfied 516. At the user's option, the web tool may provide access to a more detailed web input form or to proprietary or third-party tools for refining the project assumptions 517, which may include, but is not limited to, providing more detailed information about the property, the property's energy usage or load profile, or system design or permitting costs. After a user finishes refining these project assumptions, the final refined pre-project projected results are displayed via the web tool 518. If the project applicant cannot satisfy underwriting criteria, the web tool may notify the user of this deficiency, including how such deficiencies may be removed or resolved 519. If the user is satisfied with the final projected project results, the web tool provides an option to generate a project term sheet 521. The project application process is completed when the property owner either chooses not to generate and execute a project term sheet 521 or chooses to generate, execute and submit the project term sheet.

Another embodiment of the present invention enabled by the uniform credit profile provided by the governmental program and senior property lien allows for a more streamlined sourcing and underwriting process by bringing similar uniformity to project parameters and credit analysis. Usually, underwriting requires a deal-by-deal analysis of the customer's personal or corporate credit. The business model embodiment of the present invention focuses underwriting and credit analysis on the underlying real property and compliance with programmatic criteria sufficient for senior lien placement. This, in turn, enables the provider to source capital with more certainty by entering into capital sourcing agreements conditioned upon hitting pre-determined project internal rates of return (IRRs) pursuant to standardized underwriting terms. This creates scalability of financing and enables a provider to model for offering a fixed-price for: (i) payment of an installation price to a project developer; and/or (ii) a desired energy price discount or other project economic benefit to a property owner. An online platform could be hosted on the Internet to educate customers, and allow them to select such a fixed-price offer based on predefined project parameters such as, but not limited to, utility provider, utility tariff rate and pricing structure, site (e.g., roof) condition, distributed energy project type and size, etc. The online platform could be used to provide a matrix of project finance pricing arranged by utility service territory, rate class, city or county or zip or any other logical grouping methodology sufficient to translate to fixed-pricing. The website may be used to predefine the program offer and submittal requirements, including, but not limited to required forms and consents, program agreements, deadlines and milestone schedules, etc.

A web-enabled distributed energy system business product can evolve to account for real-time monitoring of system performance and dynamic pricing based upon time of use (TOU) charges and adjustments to federal, state and local energy policy. The energy equipment that is installed as part of a successful distributed energy project may be remotely monitored using telemetric devices with the measurement or feedback from the devices transmitted wirelessly via cellular or other internet-connected technology. This information can be used to provide reports to the property owner-customer, to investors and/or other project stakeholders. Although the present invention has been described in terms of present embodiments, it is to be understood that the disclosure is not intended as limiting. Various alterations and modifications should be understood to those skilled in the art after having read the above disclosures.

### Distributed Energy Project Finance Calculator

In some embodiments, the systems, media, and methods described herein comprise an online platform which allows a user to input and toggle various project assumptions in order to enable a more refined, accurate, and trusted project finance calculation of the expected value proposition from participating in the project, including, but not limited to, the anticipated energy savings or proposed installation cost payment.

In some embodiments, when sufficient property information is collected through Project Registration Form and/or APIs, refined and verified the information through the System Report Form, the information is plugged into a “Dashboard,” e.g., a web-based calculator tool. In further embodiments, the Dashboard is used to summarize and supply project-specific inputs. In addition, Demeter (the application provider) provides additional inputs and default assumptions into the Dashboard, which may include, but are not limited to, project-finance cost parameters (e.g., the interest rate, term and closing costs associated with debt and equity capital investments in the projects), PACE program parameters (e.g., closing costs and administrative fees), jurisdiction considerations (e.g., local incentives, state and local taxes), channel partner parameters (co-development or origination fees), system considerations (operating costs, replacement reserves, insurance). The information in the Dashboard is subsequently used to prepare projected project cash flow schedules.

In some embodiments, the projected project cash flow schedules are allocated in different configurations among deal and capital-funding participants, including through use of a waterfall schedule, to arrive at various cash flow/discounted cash flow schedules. Depending upon how the various capital return requirements are fixed, Demeter (the application provider) identifies certain capital investment hurdles (e.g., 12% IRR to equity over a 25-year time horizon) and utilize a goal-seek function to back-in to a maximum system cost that can be paid to a contractor based on project cost of capital and promised property owner energy rate. In further embodiments, the property owner energy rate is optionally toggled by property owners or contractors (additionally, the system cost may be further toggled by contractors) to arrive at a desired final project price upon which basis a project term sheet can be generated.

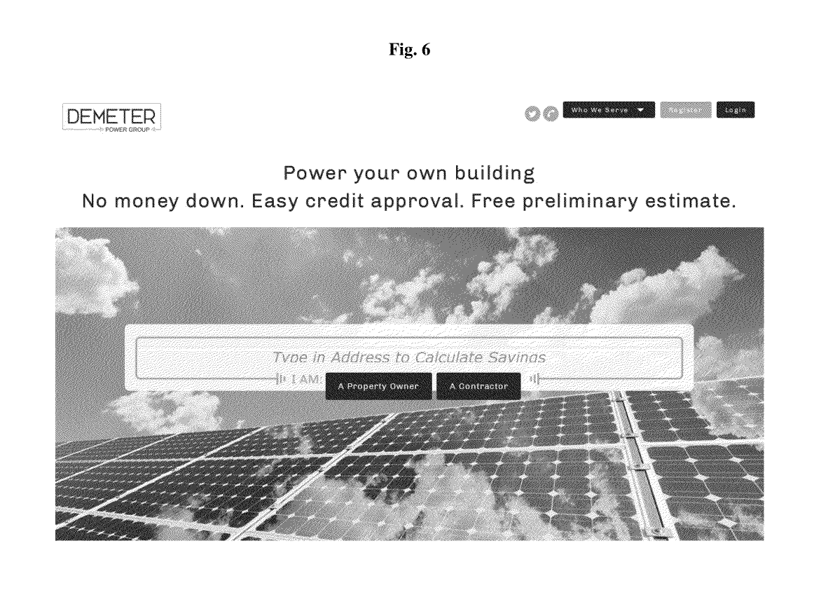

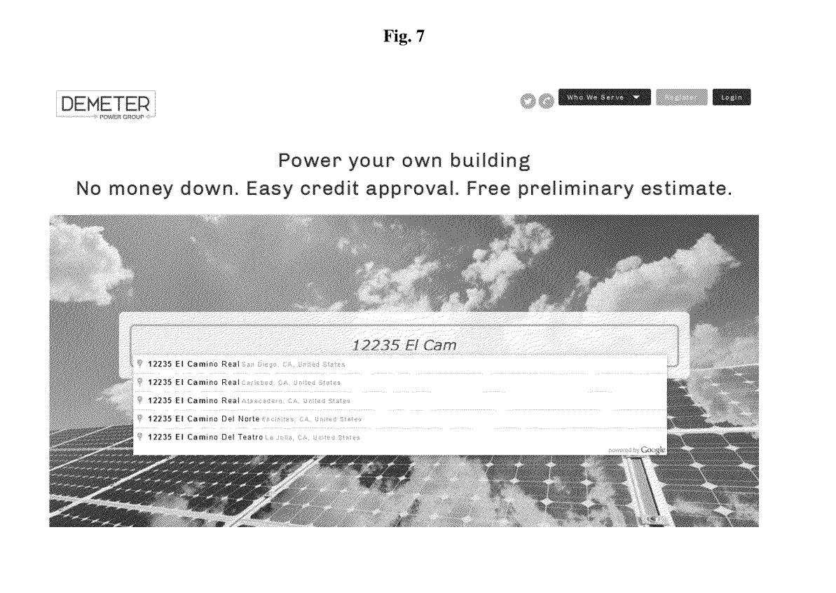

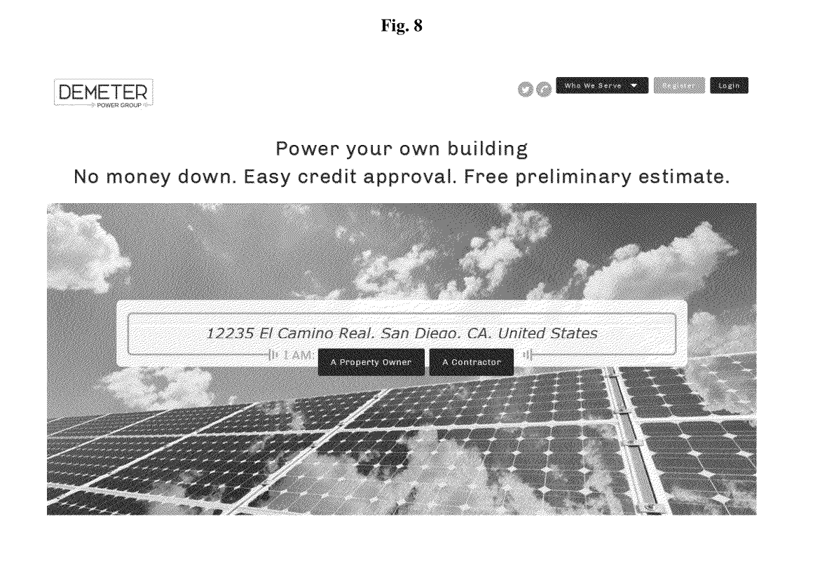

Referring to FIGS. 6-8, in a particular embodiment, a distributed energy project finance calculator includes a user interface with a text field for allowing a user to merely enter a property address to start a project calculation. In some embodiments, the user interface offers an auto-complete feature. See, e.g., FIG. 7. In some embodiments, the text field is associated with each of two buttons for submitting the property address. In a particular embodiment, the text field is associated with a button indicating that the user is a property owner and another indicating that the property owner is a distributed energy project contractor.

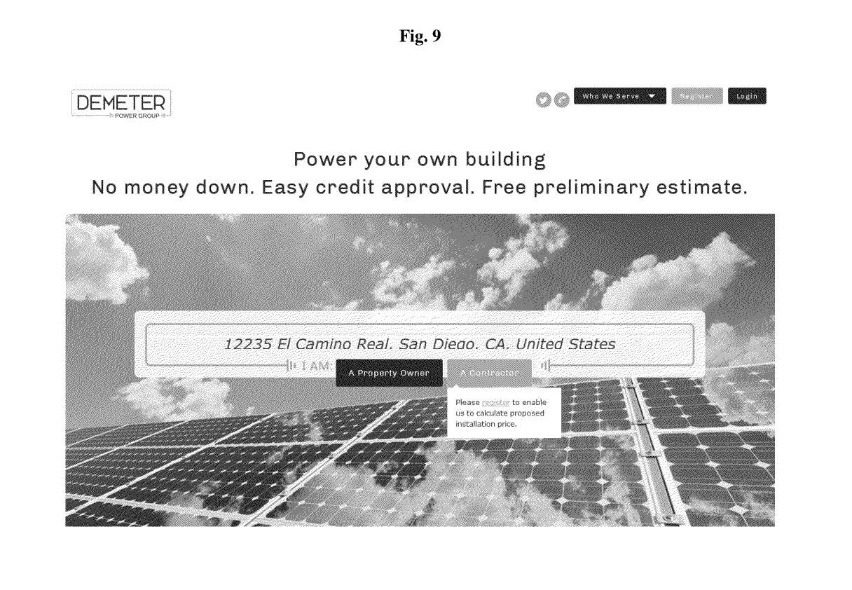

Referring to FIG. 9, in a particular embodiment, where a user enters a property address and clicks the “contractor” button to submit the information, user registration is required to move to the next step of the calculation.

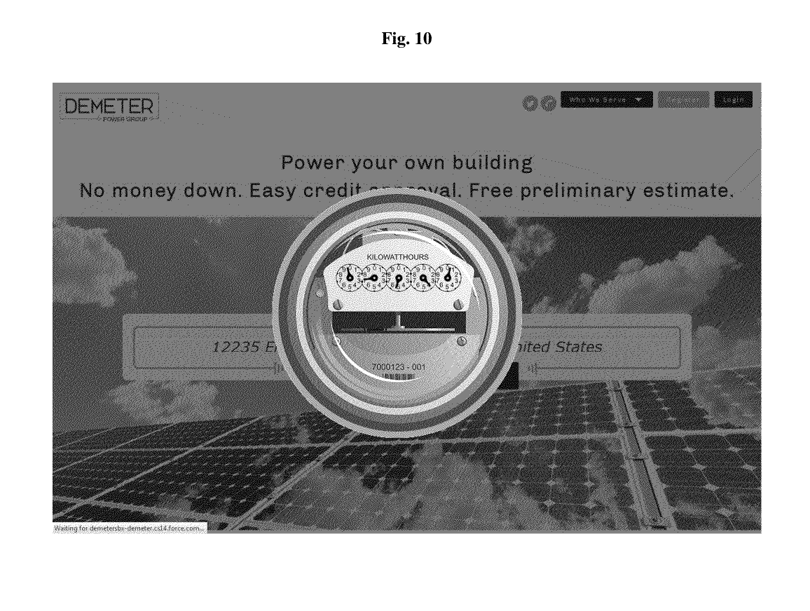

Referring to FIG. 10, in a particular embodiment, a distributed energy project finance calculator includes a user interface that displays an animation during the wait time associated with property information aggregation and cross-referencing.

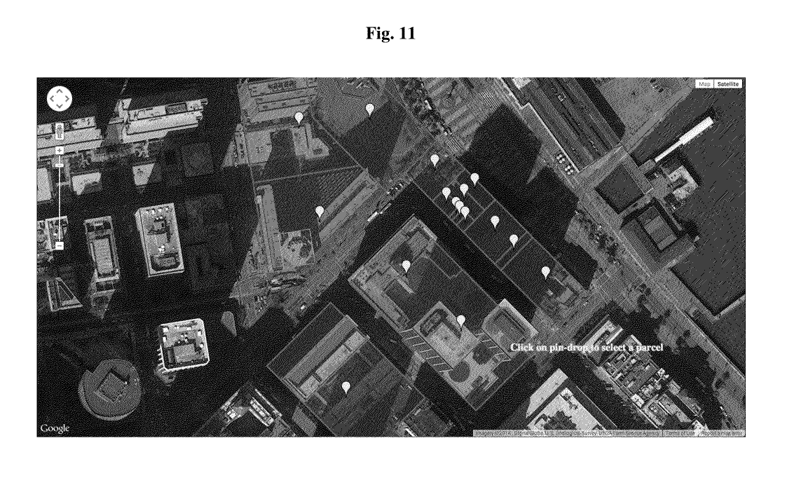

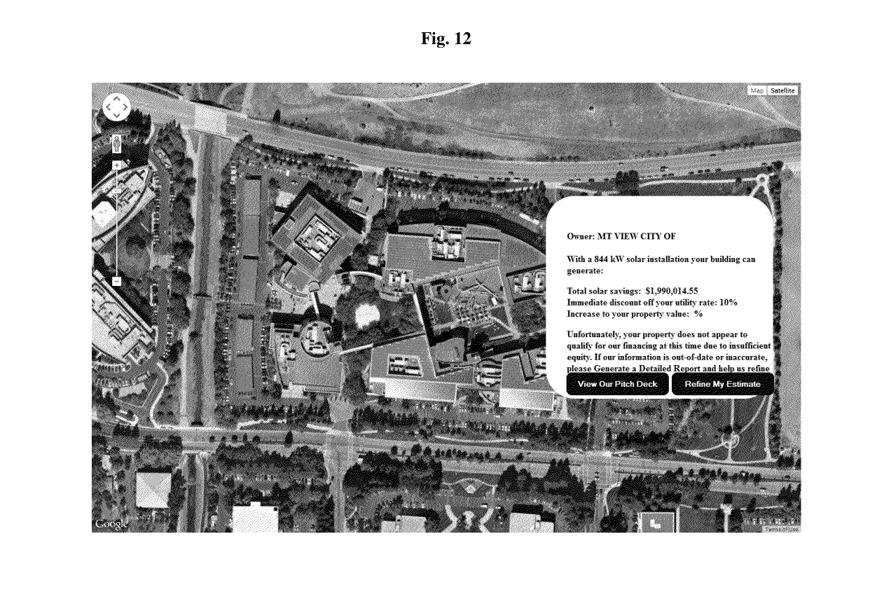

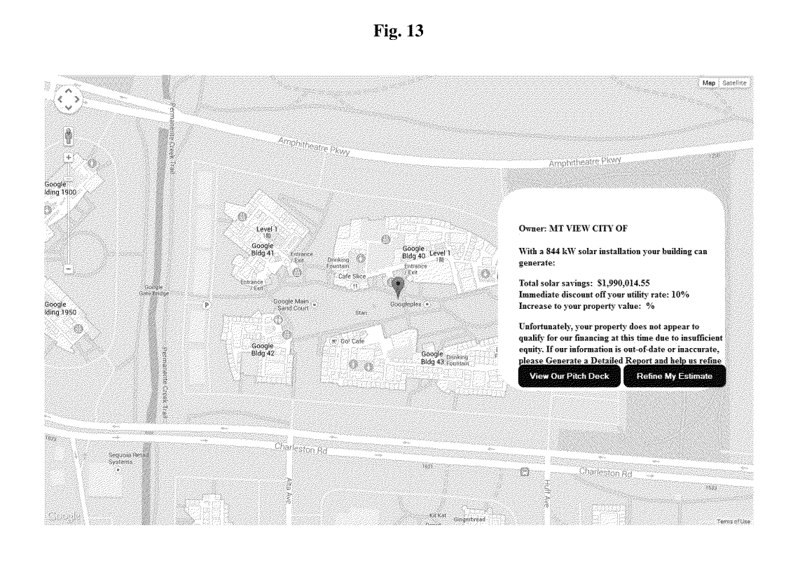

Referring to FIGS. 11-13, in a particular embodiment, a distributed energy project finance calculator includes a user interface presenting a map view of property information aggregation results. In this embodiment, the property information results include property owner, projected solar energy savings, discount off utility rate, increase to property value and elements to access a tool to refine the estimate. In some embodiments, the map is a satellite map, in other embodiments; the map is a traditional map. In some embodiments, as in FIG. 11, the map contains an image overlay showing parcel boundaries and invites a user click a pin within the parcel boundaries to select a particular real estate parcel.

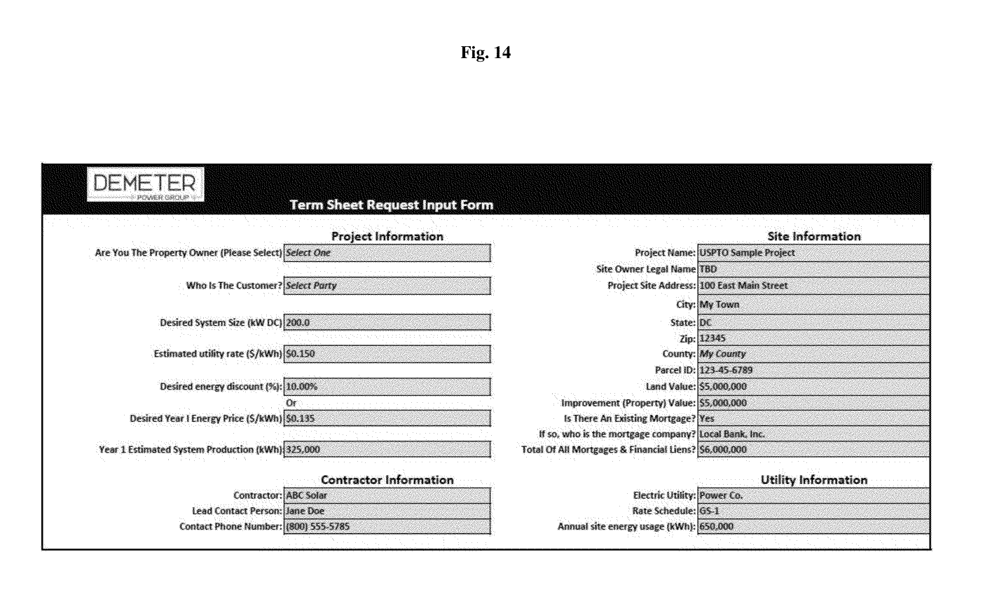

Referring to FIG. 14, in a particular embodiment, a distributed energy project finance calculator includes a user interface presenting a web form for collecting data inputs from the user. In this embodiment, the inputs are used in API search requests to generate API queries and also as data inputs for the web-based calculator function.

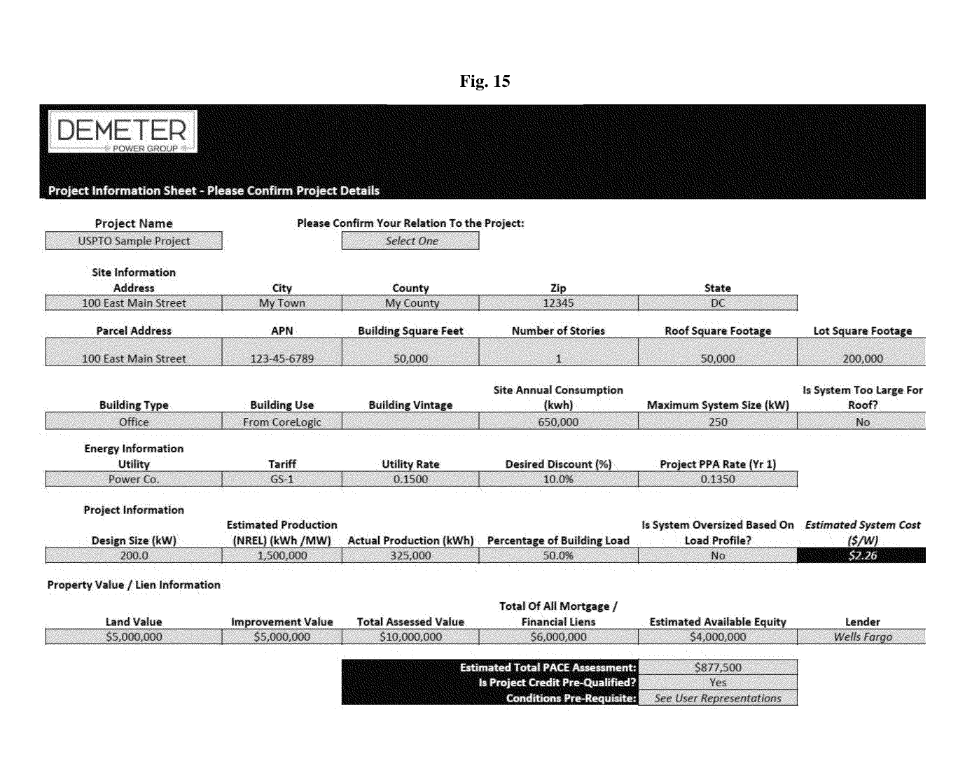

Referring to FIG. 15, in a particular embodiment, a user interface presents a preliminary user report displaying a summary of project data inputs from various API queries and preliminary project calculations. In this embodiment, the user is invited to review the form, verify the accuracy of the information and/or to replace any incorrect information with accurate information. This user interface report also identifies preliminary underwriting criteria (e.g., property assessed value, mortgage or financial liens, available equity, the identity of an existing mortgage lender, etc.). Finally, in some embodiments, the user interface report contains an estimated cost of the distributed energy system. A user optionally reviews the report in order to determine if the information underlying the calculations is accurate and if the project is economically viable from the standpoint of value proposition to the user and credit qualifications to a project investor.

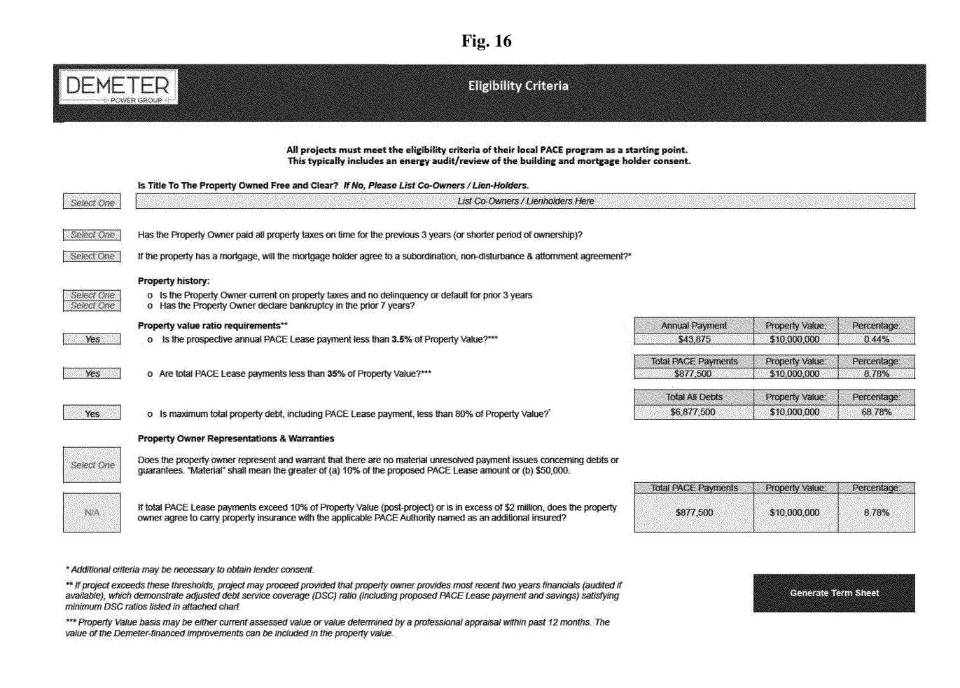

Referring to FIG. 16, in a particular embodiment, a user is required to review certain underwriting-related questions and to make affirmative representations in order to confirm that the project is credit pre-qualified. In some instances, information from API queries is used to pre-populate data fields (e.g., property values), in others calculator results are displayed (e.g., total of all annual payments), and in others ratios derived from the results of formulaic calculations are displayed (e.g., percentage of project payments to property value). If the user can affirmatively answer the questions sufficiently to comply with underwriting requirements, the user is then able to click to generate a project term sheet.

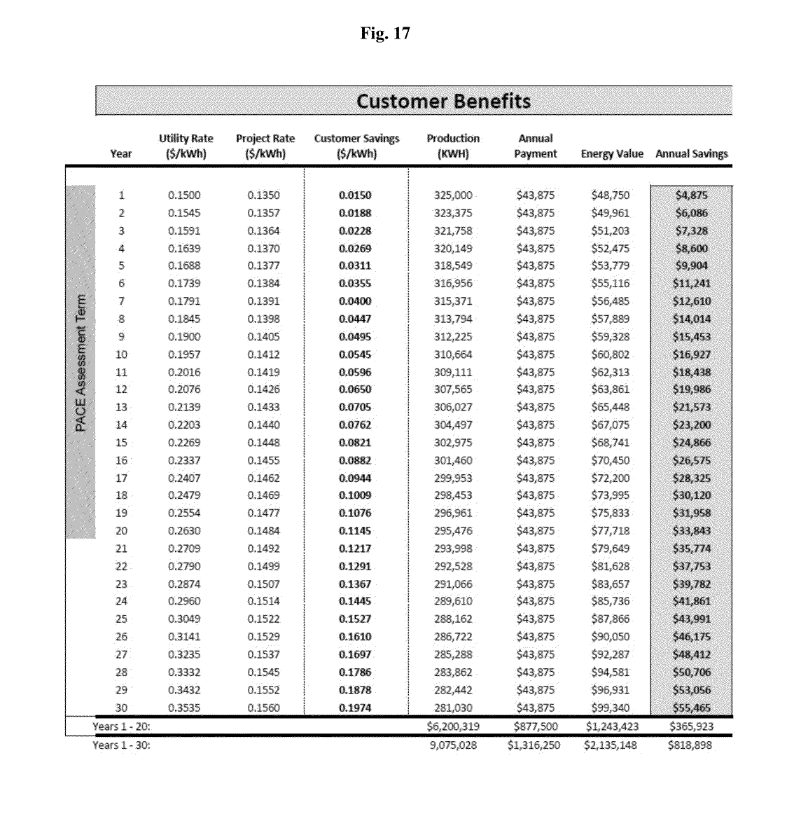

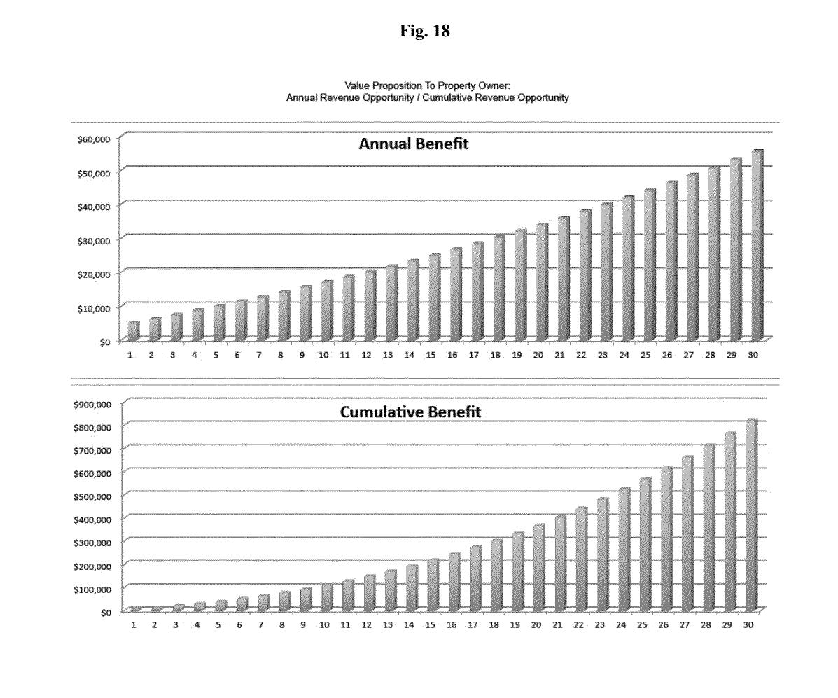

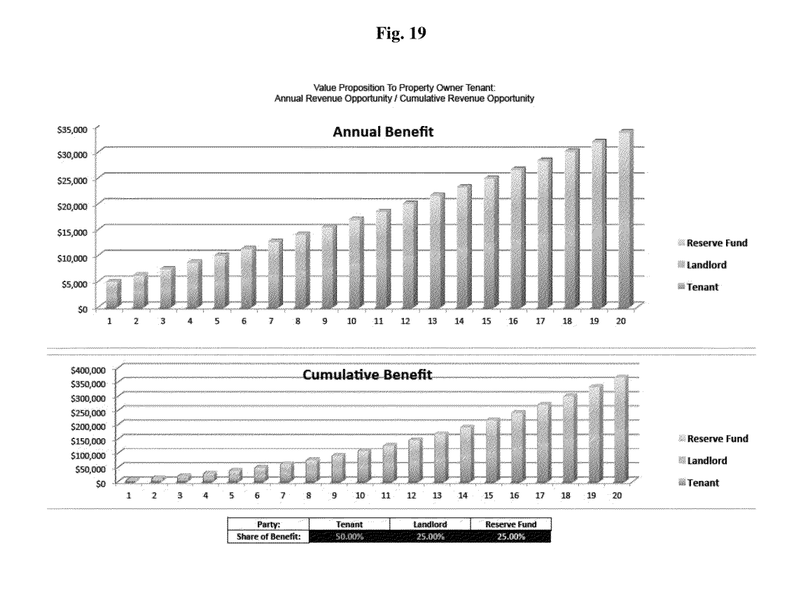

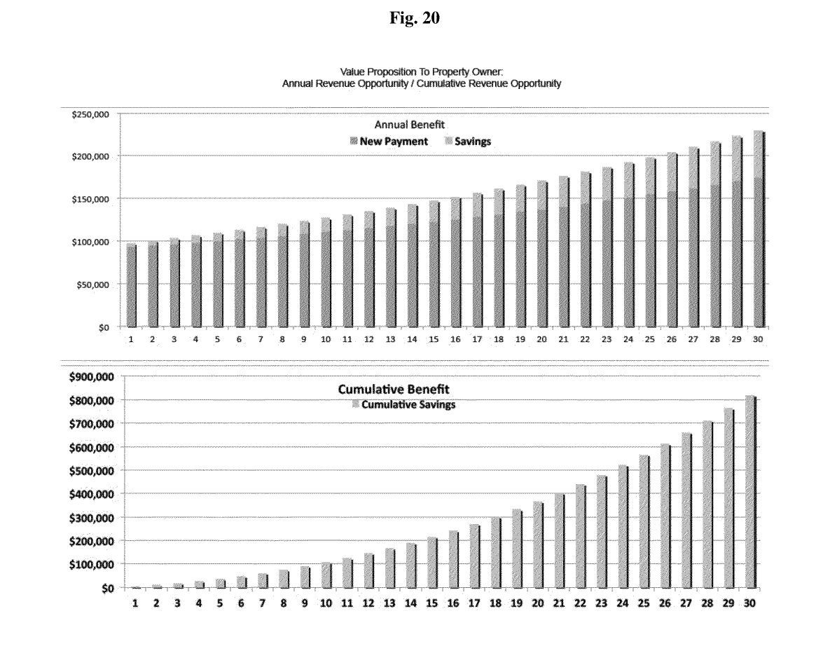

Referring to FIGS. 17-20, in a particular embodiment, the results of a distributed energy project finance calculator are presented through a user interface presenting the value proposition of the proposed project. In some embodiments, the user may refine certain project inputs to arrive at a desired set of project assumptions. In some embodiments, as in FIG. 17, the user interface utilizes a chart and in other embodiments, as in FIGS. 18-20, the user interface utilizes a graph. In some embodiments, as in FIG. 19, the user may allocate project benefits between the property owner (landlord), participating tenant(s) and reserve fund(s). In some embodiments, as in FIG. 20, the user may identify their post-project energy savings relative to their business-as-usual scenario.

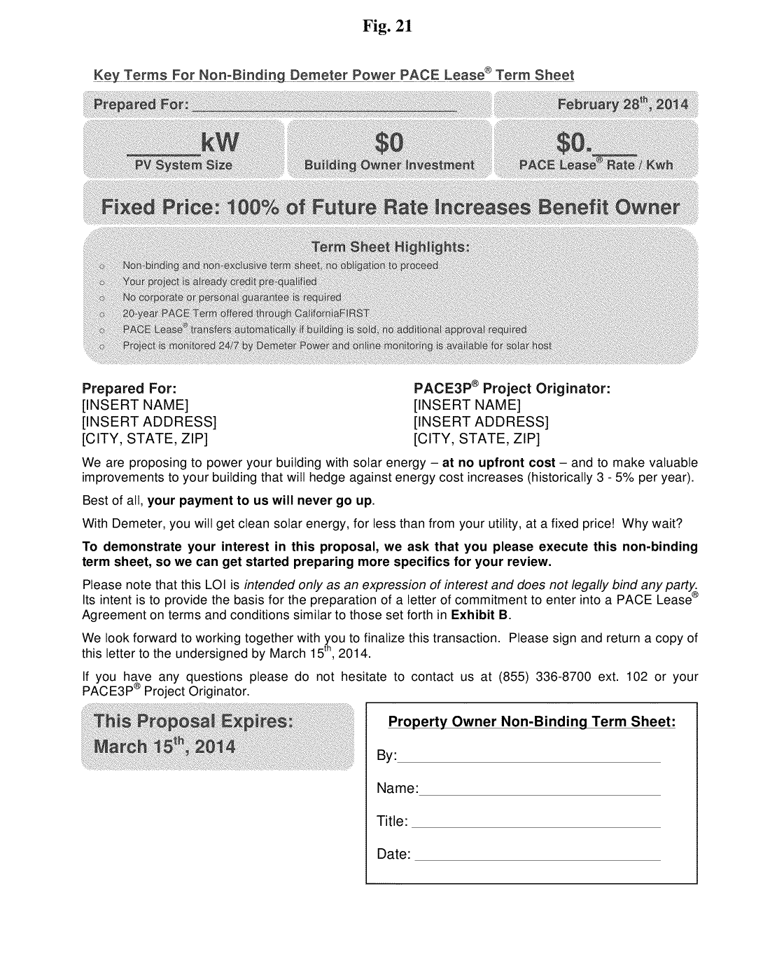

Referring to FIG. 21, in a particular embodiment, the final project-related inputs and calculator results from the user report form (see FIG. 15) are imported into a form of project term sheet, which may be rendered into a downloadable .PDF document for a user to print, execute (or e-sign) and upload to memorialize basic terms of a distributed energy project.

### Design Optimization Recommendation Tools

In some embodiments, the systems, media, and methods described herein include one or more distributed energy project system design parameters, or use of the same. In further embodiments, the systems, media, and methods described herein include one or more design optimization recommendation tools. In still further embodiments, the tools enable the user to adjust the system design parameters to suit the property, their energy goals, and their business objectives.

Many tools are suitable to optimize and adjust distributed energy project system design parameters. By way of example, in some embodiments, the design optimization recommendation tools include Folsom Labs' Helioscope (see http://www.folsomlabs.com/products). In further embodiments, the Helioscope tool enables a web-user to design a solar installation using a Google Maps interface by drawing the outline of the system, choosing technology components (e.g., solar panels and inverters each listed by manufacturer), evaluating tilt, azimuth and shading or ground cover ratio (GCR) and to then adjust design characteristics to arrive at an optimal system design based on output and cost considerations.

By way of further example, in some embodiments, the design optimization recommendation tools include the National Renewable Energy Laboratory (NREL) optimization tools for sizing energy storage component for pairing with a distributed solar installation. In further embodiments, the optimization tools for sizing energy storage components allow a user to: (a) plug in certain building characteristics (e.g., building type, size, use, geographic location, etc.) to arrive at a “typical” building energy load profile; (b) estimate energy costs for that building and load by analyzing utility pricing under the most likely utility rate tariff; and (c) design a distributed energy system with solar and energy storage by optimizing battery system design based on system costs and anticipated benefits. In still further embodiments, the preliminary estimates could then become far more accurate upon obtaining actual historical energy use information based on interval data derived either from a customer, their utility provider or some other third-party source of the data (e.g., a third-party energy storage firm who has been granted access to the data).

The design optimization recommendation tools are suitably implemented in a variety of ways. In various embodiments, a link is provided to the design optimization recommendation tool software, the software is hosted in an i-frame, pop-up, or modal window within the website, or the software is embedded within the website or hosted with the website. In further embodiments, the outputs from the optimization tool (e.g., system size, system cost, project generation output, etc.) are used to override preliminary assumptions in either the User Registration Form (see FIG. 14) or the User System Report Form (see FIG. 15).

### Digital Processing Device

In some embodiments, the systems, media, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, Groovy, or Apex (for the Force.com platform). In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Web Browser Plug-In

In some embodiments, the computer program includes a web browser plug-in. In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the systems, media, and methods disclosed herein include one or more databases, or use of the same. In view of the disclosure provided herein, those of skill in the art will recognize that many databases are suitable for storage and retrieval of property and project information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

### EXAMPLES

The following illustrative examples are representative of embodiments of the software applications, systems, and methods described herein and are not meant to be limiting in any way.

### Example 1

### Property Owner User

First, a user, who is a property owner contemplating a distributed energy project, identifies a subject property. The user visits a funding portal website and types in a property address or other property identification information, which optionally includes the owner name or assessor's parcel number (APN) or information associated with the property's latitudinal and longitudinal coordinates. If the entered information is sufficient to conclusively identify the real estate parcel, the user will be presented with results.

Second, the user optionally refines the subject property identification to obtain sufficient information to run database queries. The user is shown an online map encompassing the subject property. The user, in some cases, is shown a map with a parcel boundary overlay (e.g., as a .png file) and may point a cursor and select a point designating a location within the subject parcel boundaries. Alternatively, in response to the property search, the website presents the user with a map with particular parcel polygon boundaries within a certain buffer area of the latitudinal and longitudinal point (e.g., measured in meters). The user is then asked to select a parcel or a point within the parcel that will be used to designate the subject real estate parcel for purposes of initiating a query to a database. If the property cannot be located, the user is then presented with a window asking the user to type in the APN for the subject real estate parcel.

Third, results are displayed to the user, wherein user is shown the results of API queries to various databases that have gathered information about the subject real estate parcel in one of two formats: 1) if the dataset from the database queries is complete, the user is shown a map of the subject property with a text box that contains information with basic details of implementing the distributed energy project and the project value proposition and given the opportunity to refine the project parameters; or 2) if the dataset from the database queries is incomplete and additional information is needed for inputs necessary to perform calculations, the user is shown an online Project Registration Form and is asked to manually type in information for each missing field and/or to correct inaccurate information in each field.

Fourth, the user is presented a form including fields in which to type in information about the distributed energy project, the real estate site, the contractor or project representative and the utility provider to the real estate site. This information optionally includes, but is not necessarily limited to: 1) Project Identification Information: the user identifies the property owner, property manager or representative, contractor or other channel partner, the customer (landlord or tenant), the desired distributed energy system size (e.g., 200 kilowatts (kW)), the estimated utility rate to the site (e.g., $0.15 per kilowatt-hour (kWh)) and desired discount-off the utility rate (e.g., 10%) or alternatively the desired contract price expressed as a cost per kWh (e.g., $0.135 per kWh) and the year-one estimated system production (e.g., 325,000 kWh); 2) Real Estate Site: a Project Name, the site owner's legal name, the site's property address, the city, state, zip, county and APN of the subject site, the assessed value (both land and improvement value), whether there is an existing mortgage and, if so, the total amount of all mortgage and financial liens and the mortgage company; 3) Contractor or Project Representative: the contracting or channel partner organization, a contact person within the organization and contact information (e.g., email, address or phone number); and 4) Utility Information: the electric utility provider, the customer's electricity rate schedule and estimated annual energy usage per kWh.

Next, the user is provided the opportunity to refine the project parameters. Once the user has identified sufficient information to run the calculator tool, the website funding portal displays a map with the value proposition text box. At this stage, the user is then asked to click and register for a user license to use the funding portal website functionality for generating and refining project “Reports.” After successfully registering, the user is permitted to click to go to another page where the website displays a System Report Form. The user is asked to review the System Report Form for any missing or inaccurate information about their project, which has been auto-populated using information from the API queries or the Project Registration Form. The user is asked to review the information and either verify its accuracy (if auto-populated from API queries, the Project Registration Form or internal algorithms) or to fill-in missing information as follows: 1) all of the information from the Project Registration Form; 2) building square feet, number of stories, roof square footage, lot square footage, building type, building use, building vintage, site annual consumption (kWh), the maximum system size based on roof size; 3) the site's production factor (e.g., NREL estimated kWh based on geographic location), the percentage of building load to be met by the distributed energy system; and 4) the estimated available equity based on net of assessed value less total of all mortgages and financial liens. The user is provided a display of the estimated total estimated cost of the PACE assessment over the financing term, whether the project is credit pre-qualified and asked to review certain project pre-requisites and conditions.

Thereafter, Project Reports are generated. The user is displayed a series of charts and graphs in the Project Reports section of the portal. The user optionally changes information on the System Report Form or on any of the Reports to effectuate changes to the project parameters and project input assumptions. For example, the user optionally adjusts the Site Owner discount or Project Projection Period (e.g., over 20-years or 30-years) to examine total benefit and increase to property value. The user optionally examines total project economic benefit, including as broken out into percentages that may be toggled between landlord, tenant(s), and/or reserve fund. The user optionally examines a chart that shows their new energy costs and project savings over a term and may be able to evaluate the likely contract termination cost using various acceptable measurements.

The user is next presented with a web form including a series of questions they must affirmatively answer. As some of these questions are a proprietary trade secret, they are presented as an example for illustration purposes only. The user is asked to verify: 1) that the property is either owned free and clear or is asked to identify (or verify) holders of pre-existing mortgages or financial lien holders; 2) that the property has paid all property taxes on time for a certain period of time; 3) that they will agree to assist in obtaining a subordination, non-disturbance and attornment agreement (SNDA) from the mortgage holder; 4) that the property owner is current on all property taxes has no history of default in a prior time period (e.g., 3 years); and (5) that the property owner has not declared bankruptcy in the prior time period (e.g., 7 years). The user is presented with information reflecting internal underwriting analysis based on the inputted information that the payments from the prospective contract are less than a certain percentage of the property value (e.g., 3.5%) or that together with financial liens are less than a certain percentage of property value (e.g., 80%). Finally, the property owner must represent and warrant that there are no material unresolved financial liens and must indicate that contract payments do not exceed a certain percentage of property value (e.g., 10%). Once the user completes the User Representations Form, they may be asked to review a Final Report before clicking to generate a term sheet.

Last, a term sheet is optionally generated. If the user is interested in pursuing a project after reviewing the Final Report, they optionally choose to generate a Project Term Sheet. If the user determines not to generate a Project Term Sheet, the process ends. If the user determines to proceed, they click to generate a Project Term Sheet.

### Example 2

### Contractor User

First, a user, who is a channel partner contemplating a distributed energy project, identifies a subject property. The user visits funding portal website and types in a property address or other property identification information, which may include owner name or assessor's parcel number (APN) or information associated with the property's latitudinal and longitudinal coordinates. If the entered information is sufficient to conclusively identify the real estate parcel, the user will be presented with results.

Second, the user optionally refines the subject property identification to obtain sufficient information to run database queries. The user is shown an online map encompassing the subject property. The user is optionally shown a map with a parcel boundary overlay (e.g., as a .png file) and may point a cursor and select a point designating a location within the subject parcel boundaries. Alternatively, in response to the property search, the website presents the user with a map with particular parcel polygon boundaries within a certain buffer area of the latitudinal and longitudinal point (e.g., measured in meters). The user is then asked to select a parcel or a point within the parcel that will be used to designate the subject real estate parcel for purposes of initiating a query to a database. If the property cannot be located, the user is presented with a window asking the user to type in the APN for the subject real estate parcel.

Third, the user is shown the results of API queries to various databases that have gathered information about the subject real estate parcel in one of two formats: 1) if the dataset from the database queries is complete, the user is shown a map of the subject property with a text box that contains information with basic details of implementing the distributed energy project and the project value proposition and is provided with an opportunity to refine the project parameters; or 2) if the dataset from the database queries is incomplete and additional information is needed for inputs necessary to perform calculations, the user is shown an online Project Registration Form and the user is asked to manually type in information for each missing field and/or to correct inaccurate information in each field.

Fourth, the user is presented a form including fields in which to type in information about the distributed energy project, the real estate site, the contractor or project representative and the utility provider to the real estate site. This information may include, but is not necessarily limited to: 1) Project Identification Information: the user identifies the property owner, property manager or representative, contractor or other channel partner, the customer (landlord or tenant), the desired distributed energy system size (e.g., 200 kilowatts (kW)), the estimated utility rate to the site (e.g., $0.15 per kilowatt-hour (kWh)) and desired discount-off the utility rate (e.g., 10%) or alternatively the desired contract price expressed as a cost per kWh (e.g., $0.135 per kWh) and the year-one estimated system production (e.g., 325,000 kWh); 2) Real Estate Site: a Project Name, the site owner's legal name, the site's property address, the city, state, zip, county and APN of the subject site, the assessed value (both land and improvement value), whether there is an existing mortgage and, if so, the total amount of all mortgage and financial liens and the mortgage company; 3) Contractor or Project Representative: the contracting or channel partner organization, a contact person within the organization and contact information (e.g., email, address or phone number); and 4) Utility Information: the electric utility provider, the customer's electricity rate schedule and estimated annual energy usage per kWh.

Next, the user is provided the opportunity to refine the project parameters. Once the user has identified sufficient information to run the calculator tool, the website funding portal displays a map with the value proposition text box. At this stage, the user is asked to click and register for a user license to use the funding portal website functionality for generating and refining project reports. After successfully registering, the user is permitted to click to go to another page where the website displays a System Report Form. The user is asked to review the System Report Form for any missing or inaccurate information about their project, which has been auto-populated using information from the API queries or the Project Registration Form. The user is asked to review the information and either verify its accuracy (if auto-populated from API queries, the Project Registration Form or internal algorithms) or to fill-in missing information as follows: 1) all of the information from the Project Registration Form; 2) building square feet, number of stories, roof square footage, lot square footage, building type, building use, building vintage, site annual consumption (kWh), the maximum system size based on roof size; 3) the site's production factor (e.g., NREL estimated kWh based on geographic location), the percentage of building load to be met by the distributed energy system; 4) the estimated available equity based on net of assessed value less total of all mortgages and financial liens; 5) the estimated system cost. The user is able to toggle all project parameters simply by changing the proposed Estimated System Cost. The user is displayed the estimated total estimated cost of the PACE assessment over the financing term, whether the project is credit pre-qualified and asked to review certain project pre-requisites and conditions.

Thereafter, Project Reports are generated. The user optionally changes information on the System Report Form or on any of the Reports to effectuate changes to the project parameters and project input assumptions. For example, the user optionally adjusts the Site Owner discount or Project Projection Period (e.g., over 20-years or 30-years) to examine total benefit and increase to property value. The user optionally examines total project economic benefit, including as broken out into percentages that may be toggled between landlord, tenant(s), and/or reserve fund. The user optionally examines a chart that shows their new energy costs and project savings over a term and optionally evaluates the likely contract termination cost using various acceptable measurements.

The user is next displayed a web form with a series of questions they must affirmatively answer. As some of these questions are a proprietary trade secret, they are presented as an example for illustration purposes only. The user is asked to verify: 1) that the property is either owned free and clear or is asked to identify (or verify) holders of pre-existing mortgages or financial lien holders; (2) that the property has paid all property taxes on time for a certain period of time; (3) that they will agree to assist in obtaining a subordination, non-disturbance and attornment agreement (SNDA) from the mortgage holder; (4) that the property owner is current on all property taxes has no history of default in a prior time period (e.g., 3 years); and (5) that the property owner has not declared bankruptcy in the prior time period (e.g., 7 years). The user is presented with information reflecting internal underwriting analysis based on the inputted information that the payments from the prospective contract are less than a certain percentage of the property value (e.g., 3.5%) or that together with financial liens are less than a certain percentage of property value (e.g., 80%). Finally, the property owner must represent and warrant that there are no material unresolved financial liens and must indicate that contract payments do not exceed a certain percentage of property value (e.g., 10%). Once the user completes the User Representations Form, they may be asked to review a Final Report before clicking to generate a term sheet.

Last, a term sheet is optionally generated. If the user is interested in pursuing a project after reviewing the Final Report, they optionally generate a Project Term Sheet. If the user determines not to generate a Project Term Sheet, the process ends. If the user determines to proceed, they click to generate a Project Term Sheet.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

1. A computer-implemented system for generating project design and finance term sheets with distributed energy technologies comprising:
a) a digital processing device comprising an operating system configured to perform executable instructions and a memory; and
b) a computer program including instructions executable by the digital processing device to create a distributed energy project finance application comprising:
i) a software module configured to provide an interface for allowing a user to input real property identification information;
ii) a software module configured to conduct a plurality of search queries based on the real property identification information, the web search queries used to gather additional information about the real property from public and private databases, the additional information about the real property used to generate distributed energy project system design parameters;
iii) a software module configured to analyze the system design parameters together with project finance parameters to assess potential energy cost savings to be received by the property owner from installation of a distributed energy system affixed to the real property;
iv) a software module configured to display potential energy cost savings as a property owner economic benefit expressed as a discount off current energy prices;
v) a software module configured to provide access to design optimization recommendation tools and enable the user to adjust the system design parameters;
vi) a software module configured to calculate final projected energy cost savings from installation of the distributed energy system pursuant to the final system design parameters and project finance parameters; and
vii) a software module configured to generate a customer term sheet that memorializes the finalized system cost and project finance parameters; wherein the term sheet reflects financing to be secured by a tax lien on the real property, payment for which is collected via a special property tax assessment; wherein the term sheet comprises the potential energy cost savings and payback period to be realized by a customer, the built-cost to be paid to a contractor, and the estimated capital costs and investment returns to be provided to a lender or capital provider, each to be realized by implementing the project pursuant to the terms in the term sheet.

2. The computer-implemented system of claim 1, wherein the real property identification comprises address, assessor's parcel number (APN), or latitude and longitude coordinates, or a combination thereof.

3. The computer-implemented system of claim 1, wherein the real property identification consists of an address.

4. The computer-implemented system of claim 1, wherein the additional information about the real property comprises one or more of: the property owner's legal name, building use, building type, building square footage, number of floors, tax parcel identification number, appraised value, financial or other liens, energy usage, current utility, current time of use and demand charges, and geographic potential for renewable energy.

5. The computer-implemented system of claim 1, wherein the project finance parameters comprise one or more of: investor required rates of return, term, transaction costs, incentives, underwriting costs and requirements, distributed energy system type, and distributed energy system size.

6. The computer-implemented system of claim 1, further comprising a software module configured to calculate potential installation cost received by a distributed energy system installer.

7. The computer-implemented system of claim 1, wherein the software module configured to display potential energy cost savings further displays a channel partner installation cost or project origination fee amount.

8. The computer-implemented system of claim 1, wherein the system is used to evaluate whether predetermined project underwriting metrics are preliminarily satisfied and to enable displaying results and generating a project term sheet that may be marketed as credit pre-qualified or as credit pre-approved.

9. The computer-implemented system of claim 1, wherein the application is a web application.

10. The computer-implemented system of claim 1, wherein the project finance parameters comprise one or more pre-set project finance assumptions.

11. The computer-implemented system of claim 1, further comprising a software module configured to display a plurality of standard fixed-price offers in the form of a matrix arranged by utility tariff, rate structure, city, county, or zip code.

12. Non-transitory computer-readable storage media encoded with a computer program including instructions executable by a processor to create a distributed energy project finance application comprising:
a. a software module configured to provide an interface for allowing a user to input real property identification information;
b. a software module configured to conduct a plurality of search queries based on the real property identification information, the web search queries used to gather additional information about the real property from public and private databases, the additional information about the real property used to generate distributed energy project system design parameters;
c. a software module configured to analyze the system design parameters together with project finance parameters to assess potential energy cost savings to be received by the property owner from installation of a distributed energy system affixed to the real property;
d. a software module configured to display potential energy cost savings as a property owner economic benefit expressed as a discount off current energy prices;
e. a software module configured to provide access to design optimization recommendation tools and enable the user to adjust the system design parameters;
f. a software module configured to calculate final projected energy cost savings from installation of the distributed energy system pursuant to the final system design parameters and project finance parameters; and
g. a software module configured to generate a customer term sheet that memorializes the finalized system cost and project finance parameters; wherein the term sheet reflects financing to be secured by a tax lien on the real property, payment for which is collected via a special property tax assessment; wherein the term sheet comprises the potential energy cost savings and payback period to be realized by a customer, the built-cost to be paid to a contractor, and the estimated capital costs and investment returns to be provided to a lender or capital provider, each to be realized by implementing the project pursuant to the terms in the term sheet.

13. The storage media of claim 12, wherein the real property identification comprises address, assessor's parcel number (APN), or latitude and longitude coordinates, or a combination thereof.

14. The storage media of claim 12, wherein the real property identification consists of an address.

15. The storage media of claim 12, wherein the additional information about the real property comprises one or more of: the property owner's legal name, building use, building type, building square footage, number of floors, tax parcel identification number, appraised value, financial or other liens, energy usage, current utility, current time of use and demand charges, and geographic potential for renewable energy.

16. The storage media of claim 12, wherein the project finance parameters comprise one or more of: investor required rates of return, term, transaction costs, incentives, underwriting costs and requirements, distributed energy system type, and distributed energy system size.

17. The storage media of claim 12, further comprising a software module configured to calculate potential installation cost received by a distributed energy system installer.

18. The storage media of claim 12, wherein the software module configured to display potential energy cost savings further displays a channel partner installation cost or project origination fee amount.

19. The storage media of claim 12, wherein the application is used to evaluate whether predetermined project underwriting metrics are preliminarily satisfied and to enable displaying results and generating a project term sheet that may be marketed as credit pre-qualified or as credit pre-approved.

20. The storage media of claim 12, wherein the application is a web application.

21. The storage media of claim 12, wherein the project finance parameters comprise one or more pre-set project finance assumptions.

22. The storage media of claim 12, further comprising a software module configured to display a plurality of standard fixed-price offers in the form of a matrix arranged by utility tariff, rate structure, city, county, or zip code.

23. A computer-implemented method of assessing financing for a distributed energy project comprising:
a. receiving, by a computer, real property identification information entered by a user;
b. conducting, by the computer, a plurality of search queries based on the real property identification information, the web search queries used to gather additional information about the real property from public and private databases, the additional information about the real property used to generate distributed energy project system design parameters;
c. analyzing, by the computer, the system design parameters together with project finance parameters to assess potential energy cost savings to be received by the property owner from installation of a distributed energy system affixed to the real property;
d. displaying, by the computer, potential energy cost savings as a property owner economic benefit expressed as a discount off current energy prices;
e. providing, by the computer, user access to design optimization recommendation tools and enable the user to adjust the system design parameters;
f. calculating, by the computer, final projected energy cost savings from installation of the distributed energy system pursuant to the final system design parameters and project finance parameters; and
g. generating, by the computer, a customer term sheet that memorializes the finalized system cost and project finance parameters; wherein the term sheet reflects financing to be secured by a tax lien on the real property, payment for which is collected via a special property tax assessment; wherein the term sheet comprises the potential energy cost savings and payback period to be realized by a customer, the built-cost to be paid to a contractor, and the estimated capital costs and investment returns to be provided to a lender or capital provider, each to be realized by implementing the project pursuant to the terms in the term sheet.

24. The method of claim 23, wherein the real property identification comprises address, assessor's parcel number (APN), or latitude and longitude coordinates, or a combination thereof.

25. The method of claim 23, wherein the real property identification consists of an address.

26. The method of claim 23, wherein the additional information about the real property comprises one or more of: the property owner's legal name, building use, building type, building square footage, number of floors, tax parcel identification number, appraised value, financial or other liens, energy usage, current utility, current time of use and demand charges, and geographic potential for renewable energy.

27. The method of claim 23, wherein the project finance parameters comprise one or more of: investor required rates of return, term, transaction costs, incentives, underwriting costs and requirements, distributed energy system type, and distributed energy system size.

28. The method of claim 23, further comprising calculating, by the computer, potential installation cost received by a distributed energy system installer.

29. The method of claim 23, wherein displaying potential energy cost savings further comprises displaying, by the computer, a channel partner installation cost or project origination fee amount.

30. The method of claim 23, wherein the method is used to evaluate whether predetermined project underwriting metrics are preliminarily satisfied and to enable displaying results and generating a project term sheet that may be marketed as credit pre-qualified or as credit pre-approved.
